(19) United States
(12) Patent Application Publication
(10) Pub. No.: US 2008/0239164 A1
(43) Pub. Date: Oct. 2, 2008

(54) EZ home cinema

(75) Inventors: Ernie Liang, Los Angeles, CA (US); Rajeev Mishra, Manhattan Beach, CA (US); Donald R. Brewer, Richardson, TX (US)

Correspondence Address: PILLSBURY WINTHROP SHAW PITTMAN LLP, P.O BOX 10500, McLean, VA, 22102, US

(73) Assignee: EPSON AMERICA, INC., Long Beach, CA (US)

(21) Appl. No.: 11/731,362

(22) Filed: Mar. 30, 2007

(51) Int. Cl. H04N 5/38

(52) U.S. Cl. 348/723

(57) ABSTRACT

A projector assembly includes a projector for projecting images and a plurality of speakers for reproducing sound. The projector assembly further includes a mounting bracket connected to a surface. The projector assembly includes a support assembly connected to the mounting bracket, wherein the projector and the plurality of speakers are supported by the support assembly. A projection screen system includes a projector, a mounting assembly, and a projection screen assembly. The projection screen assembly includes a first plurality of speakers for reproducing sound transmitted thereto and a projection screen to receive the projected image. The projection screen assembly is mounted to the mounting assembly and the mounting assembly can be mounted to a horizontal surface and a vertical surface. The system includes a power cable to provide AC power between the projection screen assembly and the projector in the projector assembly.

### BACKGROUND OF THE INVENTION

Many home owners desire the cinematic experience in the comfort of their own living room, basement, or great room. Current home cinema systems are very expensive to purchase and are extremely difficult to install. A custom installer needs to be hired and cabling has to be installed above the ceilings and within the walls of the room. In addition, many components are incompatible so a large amount of time has to be spent understanding the connections (and wiring) needed to install the home cinema system. Further, current screen systems require a connection to AC power located in the ceiling or wall of the room as well as installation of the projection screen mechanism.

Accordingly, what is desirable is a packaged, full-featured home cinema system that is easy-to-install, and can be installed in a relatively short period of time.

### BRIEF DESCRIPTION OF THE DRAWINGS

FIG. 1A illustrates a projector screen assembly and a projector assembly in a home cinema system according to an embodiment of the invention;

FIG. 1B illustrates a projector assembly and a projection screen assembly utilizing wireless audio and video transmission with a receiver in the projector screen assembly according to an embodiment of the invention;

FIG. 1C illustrates a projector assembly and a projection screen assembly utilizing wireless audio and video transmission with a receiver in the projector assembly according to an embodiment of the invention;

FIG. 1D illustrates a projector assembly and a screen assembly utilizing wireless audio and video transmission with a receiver in both the projector assembly and the projection screen assembly according to an embodiment of the invention;

FIG. 1E illustrates a specific home cinema system including a specific A/V receiver according to an embodiment of the invention;

FIG. 2A illustrates video signal distribution according to an embodiment of the invention;

FIG. 2B illustrates power distribution in the EZ Home Theatre system according to an embodiment of the invention;

FIG. 3 illustrates remote control operation of the EZ home cinema system;

FIG. 4A illustrates a top perspective view of a projector assembly according to an embodiment of the invention;

FIG. 4B illustrates an exploded view of the support assembly;

FIG. 4C illustrates a support assembly includes two side support areas and and a center area according to an embodiment of the invention;

FIG. 4D illustrates how sound is reflected from the central location to the rear walls and then to viewers in the center of the room according to an embodiment of the invention;

FIG. 5A illustrates an exploded top perspective view of the projection screen assembly according to an embodiment of the present invention;

FIG. 5B illustrates a mounting assembly for the projection screen assembly according to an embodiment of the invention;

FIG. 5C illustrates a side view of a semi-exploded view of the projection screen assembly according to an embodiment of the invention;

FIG. 5D is a view from a left side of the projection screen assembly; and

FIG. 5E is a front view of speaker assemblies in the projection screen assembly according to an embodiment of the invention.

### DETAILED DESCRIPTION OF THE INVENTION

The easy-to-install home cinema system may be plugged into any electrical socket and does not require any Custom Electrical Design and Installation.

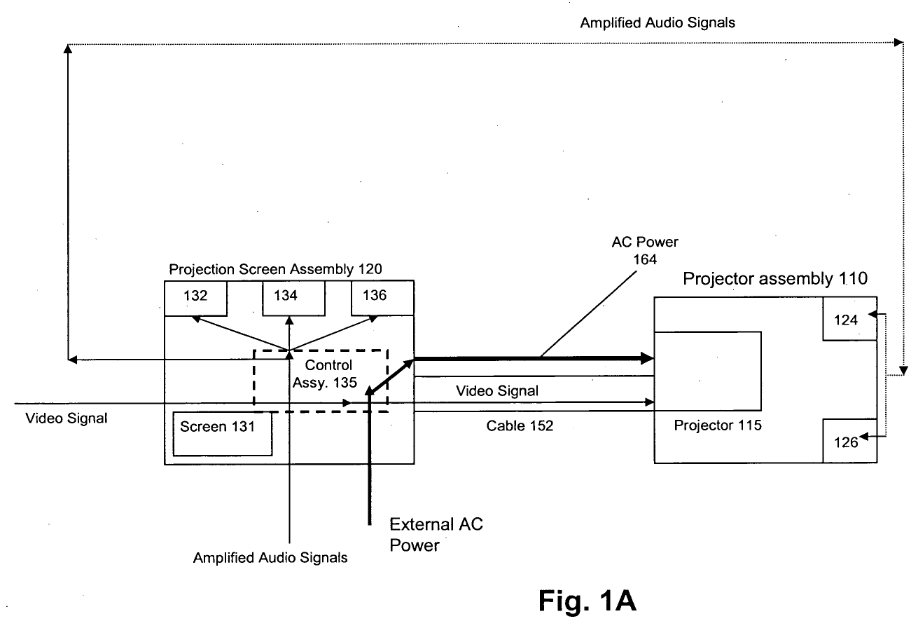

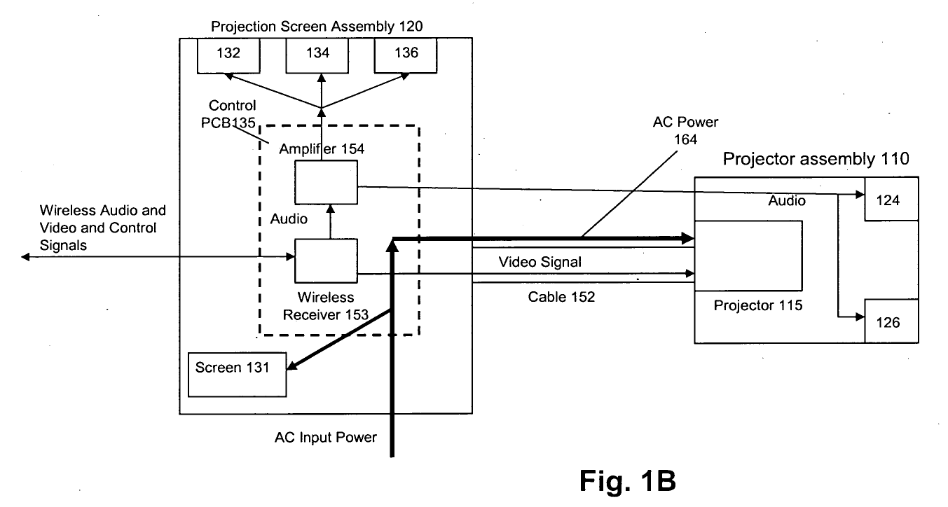

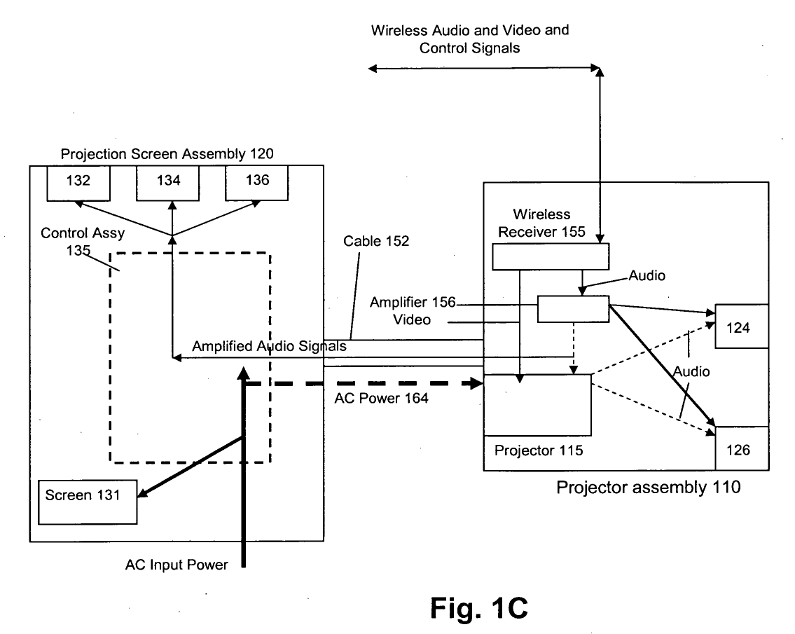

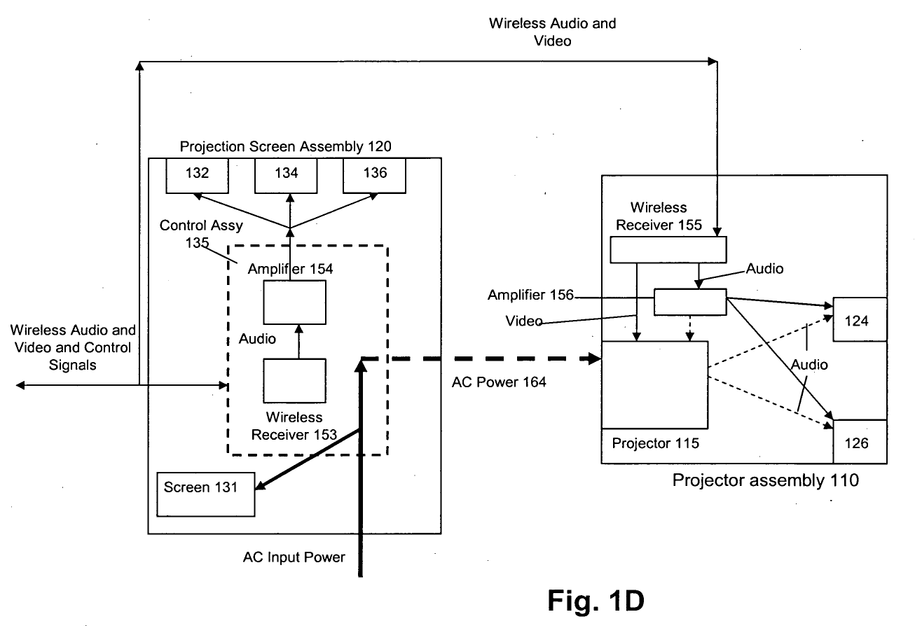

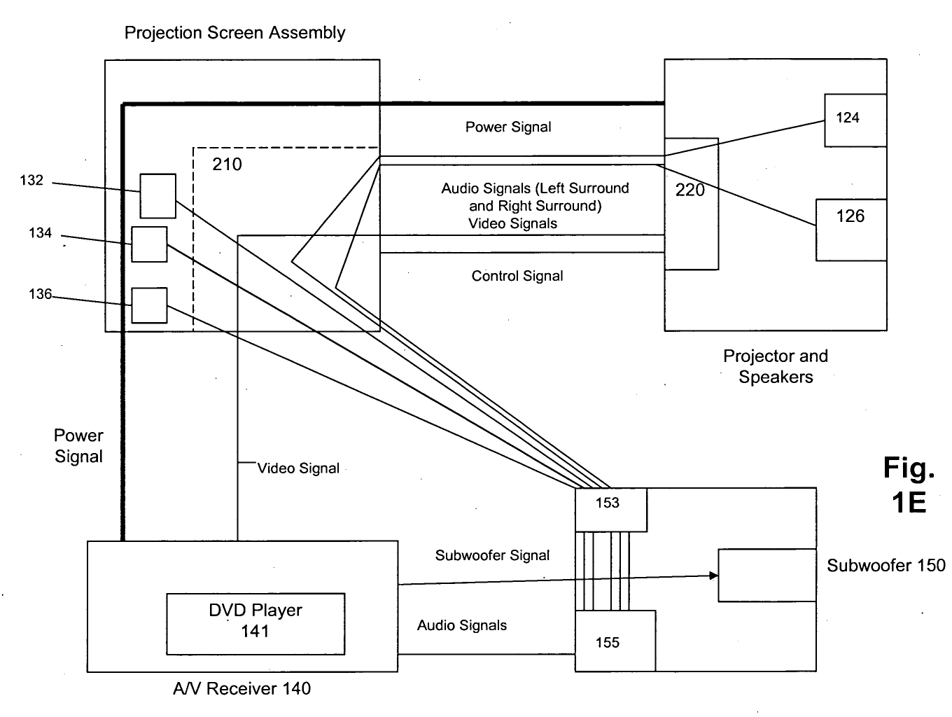

FIG. 1A illustrates a projector screen assembly and a projector assembly in a home cinema system according to an embodiment of the invention. The projector screen assembly and projector assembly can be part of an easy-to-install (EZ) home cinema system. As illustrated in FIG. 1A, the projector screen assembly can received amplified audio signals from an audio source, video signals from a video source, and power from an external power source. In the embodiment of the invention illustrated in FIG. 1A, the projector assembly 110 includes a projector 115 and a plurality of speakers, e.g., speakers 124 and 126. The projection screen assembly includes a screen 131, a control assembly 135, and a plurality of speakers 132, 134, and 136.

In the embodiment of the invention illustrated in FIG. 1A, the video signal is transmitted from a video source and passes through the projection screen assembly 120. In an embodiment of the invention, the video signal is routed through a control assembly 135 in the projection screen assembly 120, or the video signal can also routed directly to the projector 115 without passing through the projector screen assembly 120. The video signal passes from the projection screen assembly 120 to the projector 115 in the projection assembly 110. Images carried by the video signal are projected from the projector 115 back to the screen 131 of the projection screen assembly.

In the embodiment of the invention illustrated in FIG. 1A, the amplified audio signal is received from an audio source at the projection screen assembly 120. Illustratively, the amplified audio signal may be received at a control assembly 135 of the projection screen assembly 120. A number of signals in the amplified audio signal may be routed to speakers in the projection screen assembly 120. For example, three audio signals may be routed to speakers 132, 134, and 136 in the projection screen assembly 120. Illustratively, these three channels of audio signals may be a front left sound signal, a front center sound signal, and a front right sound signal.

The projection screen assembly 120 (e.g., the control assembly 135) may pass other channels of the amplified audio signal from the projection screen assembly to the projector assembly 110. For example, two channels of the amplified audio signals may be input to the projector assembly 110 and then to two speakers in the projector assembly 124 and 126. Illustratively, these two channels may be the rear left surround sound signal and the rear right surround sound signal. In an embodiment of the invention, the amplified audio signals may be input directly to the two speakers 124 and 126. In another embodiment of the invention, the amplified audio signals may be input to input audio jacks the projector 115 of the projector assembly 115 and the projector 115 may also input audio output jacks which are connected to the speakers 124 and 126.

FIG. 1B illustrates a projector assembly and a projection screen assembly utilizing wireless audio and video transmission with a receiver in the projector screen assembly according to an embodiment of the invention. In the embodiment of the invention illustrated in FIG. 1B, a wireless receiver 153 is included in the projection screen assembly. The wireless receiver 153 receives wireless audio and video signals from a wireless transmitter. For example, there are manufacturers who have developed transmitters which transmit uncompressed high definition video signals along with audio signals. In an embodiment of the invention, control signals and/or authorization signals may also be transmitted by the wireless transmitter. Illustratively, if the video signal includes digital rights management information, the transmitter and the wireless receiver 153 engage in an authorization process before video is transmitted in order to identify if the receiver is authorized to receive the high definition video. The wireless receiver 153 may be located on a control assembly 135. In the embodiment of the invention illustrated in FIG. 1B, the audio received at the wireless receiver 153 is input to amplifier 154 which amplifies the audio signals. A number of channels of the amplified audio signal are routed to the plurality of speakers 132, 134, and 136 in the projection screen assembly 120. For example, three channels (e.g., the front left signal, the front center signal, and the front right signal) are input to the corresponding speaker 132, 134, or 136.

The video signal is transmitted from the control assembly 135 to the projector 115 of the projector assembly 110 via a cable 152. In addition, remaining channels of the amplified audio signals are output from the amplifier 154 and transmitted from the control assembly 135 to the projector 115 of the projector assembly 110 via the cable 152. Illustratively, one cable with a plurality of conductors may transport both the video signal and the remaining channels of the amplified audio signal to the projector 115. Illustratively, one physical cable 152 may be utilized to transport the power signal, e.g., a cable jacket may include conductors, wires, or cables for the power, video, and audio signals. The video signals are utilized by the projector 115 to project images corresponding to the video signal back to the screen 131 of the projection screen assembly 120. The remaining channels of the amplified audio signals are output from the projector 115 to the plurality of speakers 124 and 126. Illustratively these channels may be the rear left surround sound signal and the rear right surround sound signal.

In an embodiment of the invention, a wireless receiver may also receive control signals for the audio/visual equipment and/or the projector. The control signals may be transmitted wirelessly via a lower bandwidth wireless protocol or an infrared wireless protocol. Although, FIG. 1B illustrates one wireless receiver 153, this is for simplicity, because two physical wireless receivers may be utilized, i.e., one for the high bandwidth RF video signal and audio signal reception/transmission and one for the low bandwidth RF or infrared control signals. In an embodiment of the invention, the wireless receiver 153 (or wireless receivers 153) may be a transceiver in order to transmit wireless signals. The control signals received by the wireless receiver 153 may be transmitted back to audio and video source in order to control the operation of the audio and video source. In an embodiment of the invention, the control signals received by the wireless receiver 153 may be transmitted to the projector assembly in order to control operations of the projector assembly.

FIG. 1C illustrates a projector assembly and a projection screen assembly utilizing wireless audio and video transmission with a receiver in the projector assembly according to an embodiment of the invention. In this embodiment of the invention, the only wireless receiver 155 is in the projector assembly 110. The wireless receiver 155 may be located on a separate circuit board or may be installed in a module that is attached to one of either the projector 115 or one of the plurality of speakers 124 and 126. In an embodiment of the invention, the wireless receiver 153 may be a transceiver in order to transmit wireless signals. The wireless receiver 155 receives audio and video wirelessly from a wireless transmitter from a video and an audio source. An amplifier 156 receives the audio signal from the wireless receiver and amplifies the audio signals to create an amplified audio signal. Two channels of the amplified audio signal are transmitted to the plurality of speakers 124 and 126. Illustratively, the rear left surround sound channel and the rear right surround sound channel are transmitted to the rear left speaker 124 and the rear right speaker, respectively. The wireless receiver 155 receives the uncompressed video and transmits the video to the projector 115. The projector 115 projects images corresponding to the video signal to the screen 131.

The amplified audio signals output from the amplifier 156 includes other channels besides the channels transmitted to the plurality of speakers 124 and 126 in the projector assembly 110. The other or remaining channels are transmitted to the projector screen assembly 120 via a cable 152. A control assembly 135 in the projector screen assembly 120 receives the remaining channels of the amplified audio signal and the remaining channels are transmitted to the plurality of speakers 132, 134, and 136 in the projection screen assembly. Illustratively, the remaining channels may be the front left signal, the front center signal, and the front right signal and they may be transmitted to the plurality of speakers 132, 134, and 136. For example, the speaker 132 may be the front left speaker, the speaker 134 may be the front center speaker, and the speaker 136 may be the front right speaker.

In an embodiment of the invention, a wireless receiver may also receive control signals for the audio/visual equipment. The control signals may be transmitted wirelessly via a lower bandwidth wireless protocol or an infrared wireless protocol. Although, FIG. 1B illustrates one wireless receiver 155, this is for simplicity, because two physical wireless receivers may be utilized, i.e., one for the high bandwidth RF video signal and audio signal transmission, and one for the low bandwidth RF or infrared control signal transmission. The control signals received by the wireless receiver 154 may be transmitted back to audio and video source in order to control the operation of the audio and video source. In an embodiment of the invention, the control signals received by the wireless receiver 154 may be transmitted to the projection screen assembly in order to control operations of the projection screen assembly. In an embodiment of the invention, the wireless receiver 155 may be a transceiver in order to transmit wireless signals.

FIG. 1D illustrates a projector assembly and a screen assembly utilizing wireless audio and video transmission with a receiver in both the projector assembly and the projection screen assembly according to an embodiment of the invention. In this embodiment of the invention, a wireless receiver 155 is located in the projector assembly 110 and an additional wireless receiver 153 is located in the projection screen assembly 120. In the projector assembly 110, the wireless receiver 155 receives the wirelessly transmitted audio and video signal from a wireless transmitter. The wireless receiver 155 transmits the audio signal to an audio amplifier 156 which amplifies the audio signal to create an amplified audio signal. Two channels of the amplified audio signal are transmitted from the amplifier 156 to the plurality of speakers 124 and 126. In an embodiment of the invention, the amplified audio signal may be transmitted to the projector 115 and two channels of the amplified audio signal are transmitted from the projector 115 to the plurality of speakers 124 and 126. The two channels may be the rear left surround sound signal and the rear right surround sound signal and the speakers may be the rear left speaker 124 and the rear right speaker 126, respectively. The three additional channels of the amplified audio signal may not be utilized in the projector assembly 110 in this embodiment of the invention.

The wireless receiver 153 in the projection screen assembly 120 may also receive the wirelessly transmitted audio and video signal. In this embodiment of the invention, the wireless receiver 153 receives the wirelessly transmitted video signal, but the video signal is not transferred anywhere or utilized in the projection screen assembly. The wireless receiver 153 transfers the audio signal to the amplifier 154 which generates an amplified audio signal. Three channels of the amplified audio signal are transmitted from the amplifier 154 to the plurality of speakers 132, 134, and 136. For example, the three channels of the amplified audio signal may be the front left signal, the front center signal, and the front right signal which may be input to the front left speaker 132, the front center speaker 134, and the front right speaker 136, respectively. The two other channels of the amplified audio signal are not utilized in the projection screen assembly 120 and do not need to be transferred to the projector assembly 110 because of the existence of a wireless receiver 155 in the projector assembly 110. In an embodiment of the invention, the wireless communication protocol may WHDI™ technology which enables wireless delivery of uncompressed HDTV throughout the home with video rates of up to 3 Gbps (uncompressed 1080 p!) in the 5 Ghz unlicensed band, with the same quality as a wired connection and no latency. The wireless receivers 153 or 155 may receive commands wirelessly (e.g., infrared—IR or radio frequency—RF). These wirelessly receivers 153 or 155 may be transceivers in order to transmit the control signals back to the original wireless transmitter in the audio and video data source. The original wireless transmitter may pass these control signals to audio or video devices either by a wired connection, or alternatively by infrared commands. An advantage of this solution is that the user's system audio and video components may be hidden in closet or attic, and a more powerful wireless solution could be used to allow user's standard IR or RF remote to control these components.

FIG. 1E illustrates a specific home cinema system including a specific A/V receiver according to an embodiment of the invention. An easy-to-install (EZ) home cinema system 100 includes a projector assembly 110, a projection screen assembly 120, an Audio/Video (A/V) receiver 140, and a subwoofer 150. The projector assembly 110 includes a projector 115 and a plurality of speakers 124 and 126. The projection screen assembly 120 includes a screen 131, a control assembly 135, and a plurality of speakers 132 134 136. The A/V receiver 140 includes a DVD player 141, an audio output module 142 and a video output module 144. The subwoofer 150 includes an audio amplifier 155.

A CD or DVD is placed into the DVD player 141 of the A/V receiver 140. The video signal from the DVD player is output from the video output module 143 of the DVD and A/V receiver 140. The video signal passes through the projection screen assembly 120 and is input to the projector 115 of the projector assembly. Images representative of the video signal are displayed via the projector 115 on the projection screen 131. The audio signal is output through the audio output module 142 in the A/V receiver 140 to the subwoofer 150. The subwoofer 150 includes an audio amplifier 155 which amplifies the received audio signals. The amplified audio signals are transmitted from the subwoofer 150 to the projection screen assembly 120 via cabling. A number of channels of the amplified audio signals are directed to an associated speaker in the plurality of speakers 132 134 126 installed in the projection screen assembly 120. A remaining number of channels of the amplified audio signals are directed to the projector assembly 110, and specifically to an associated speaker of the plurality of speakers 124 and 126 installed in the projector assembly 110.

A more detailed discussion of the transmission of audio signals in the EZ Home Cinema system is presented below. The audio output from the DVD player 141, which is associated with the video output from the DVD player 141 is transmitted through an audio output module 142 of the A/V receiver 140 to an input of the subwoofer 150. In an embodiment of the invention, the audio transmitted out the audio output module 142 includes five surround sound channels and the sound effects channel, i.e., a front right signal, a front center signal, a front left signal, a rear right signal, a rear left signal, as well as a subwoofer signal.

In an embodiment of the invention, the subwoofer 150 receives the audio signals and a subwoofer signal. The received subwoofer signal drives a transducing apparatus in the subwoofer to produce the associated sound. In an embodiment of the invention, the subwoofer signal may be amplified by an amplifier in the subwoofer 150. The subwoofer 150 includes an amplifier 155 (which may or may not be the same amplifier that is used for the subwoofer signal). In an embodiment of the invention, the amplifier 155 amplifies the received remaining audio signals, e.g., the surround sound audio signals and the sound effects channel, and then the remaining audio signals are divided into representative channels, e.g., the five surround sound channels or signals (i.e., the front right signal, the front center signal, the front left signal, the rear right signal, and the rear left signal) and the sound effects channel. The amplified audio signals may then be transmitted to an output audio module 153 on the subwoofer 150 which is connected to audio signal cabling.

In an alternative embodiment, the subwoofer 150 may divide up the signals into the representative channels, and include a number of amplifiers to separately amplify each of the audio signals. Each of the amplifiers amplifies an associated channel audio signal. For example, one amplifier may amplify the left front audio signal. Each of these audio amplifiers may output an associated amplifier signal (together these associated amplified audio signals may be referred to as the amplified audio signals) to an output audio module 153 of the subwoofer 150 and then to audio signal cabling.

The audio output module 153 of the subwoofer outputs the amplified audio signals to the projection screen assembly 130 via the audio signal cabling. The audio signal cabling may include a 2-pair wire for each channel of the output audio signal. In the projection screen assembly 130, there may be a cable junction 210 where the audio cabling connects to the speakers integrated into the projection screen assembly 120. The cable junction 210 may be an interconnect or may be a junction device/splitter where a number of signals are input through a first interface and output through a second interface and a third interface. The projection screen assembly 120 includes a plurality of speakers. In the embodiment of the invention illustrated in FIG. 1, the plurality of speakers may be three speakers 132, 134, and 136. For example, the plurality of speakers may be the front left speaker 132, the front center speaker 134, and the front right speaker 136. In this embodiment of the invention, three of the amplified audio signals being transmitted on three of the audio signal conductors are directed to the associated speaker in the plurality of speakers. Illustratively, the front right audio signal is transmitted to the front right speaker 136, the front center audio signal is transmitted to the front center speaker 134, and the front left audio signal is transmitted to the front left speaker 132.

The remaining amplified audio signals and associated audio signal cabling exits the cable junction 210 and are coupled to audio cabling to the surround sound speakers located in the projector assembly 110. For example, these amplified audio signals could be the rear left amplified audio signal and the rear right amplified audio signal of surround sound signals. Illustratively, the plurality of speakers in the projector assembly 110 may be a rear left speaker 124 and a rear right speaker 126. In an alternative embodiment of the invention, a cable junction 220 in the projector assembly directs the remaining amplified audio signals to a plurality of speakers in the projector assembly 110.

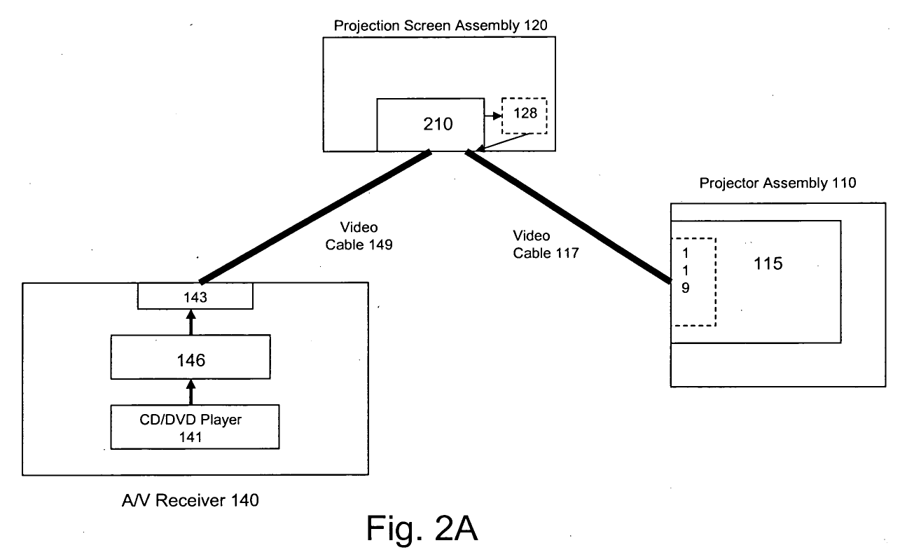

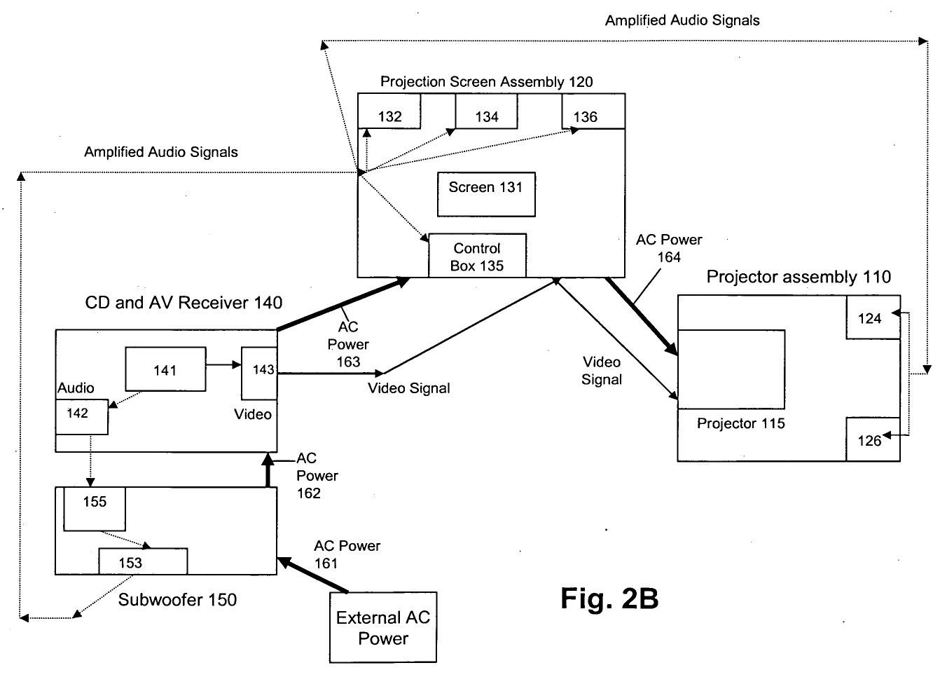

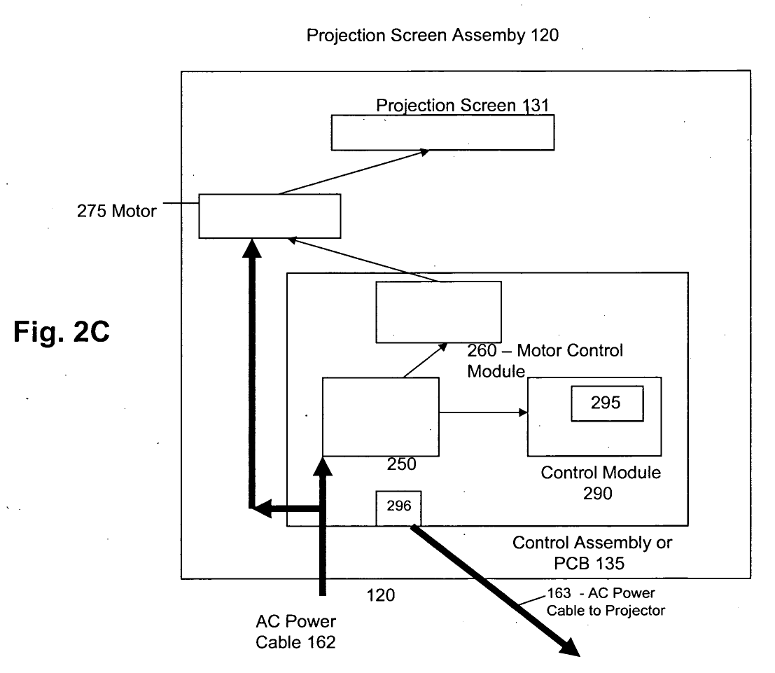

FIG. 2A illustrates video signal distribution according to an embodiment of the invention. The A/V receiver 140 may include a Component Video Output which receives a video signal from the DVD player 141. In an embodiment of the invention, the A/V receiver 140 may include a high definition video output port 143 e.g., a Digital Visual Interface (DVI) or High Definition Multimedia Interface (HDMI) output port. In an embodiment of the invention, the output port may transmit lower definition video output. In an embodiment of the invention, the high definition video output may be compatible with High-bandwidth Digital Content Protection (HDCP) Digital Rights Management technology. In an embodiment of the invention where the output port is a high definition video output port, the high definition video output port may be the video output module. The video signals from the DVD player in the A/V receiver 140 may pass through a high definition video converter 146 to the high definition video output port 143. In an alternative embodiment of the invention, audio signals from the DVD player may also pass through the high definition video converter 146 to the high definition video output port 143. The A/V receiver 140 may also receive or transmit a plurality of analog audio inputs and analog audio outputs. Alternatively, the output port 143 may be a low definition video output port.

In an embodiment of the invention where the output port is a high definition video output port, the video signals from the high definition video output port 143 are transmitted via an video cable 149 to the projection screen assembly 120. Specifically, the video cable 149 is coupled to a cable junction 210 in the projection screen assembly 120. The cable junction 210 may be the same cable junction used for the received amplified audio signals or may be a separate physical device. The cable junction 210 in the projection screen assembly 120 receives the video signal and redirects the video signal through a video cable 117 to a video input port/connector 119 of the projector 115 in the projector assembly 110. In an embodiment of invention, the projection screen assembly 120 may include a video signal amplifier 128 located at the cable junction 210 that amplifies the received video signal before the amplified video signal is transmitted to the video input connector 119 of the projector 115.

FIG. 2B illustrates power distribution in the EZ Home Theatre system according to an embodiment of the invention. The subwoofer 150 is connected to a power source (such as a standard AC power source, e.g., wall outlet), through a power cable 161. In an embodiment of the invention, a power cable 162 is coupled between an AC adapter on the subwoofer 150 and the A/V receiver 140. The A/V receiver 140 receives the AC power and converts it to DC operating voltages which drive the components and subsystems of the A/V receiver 140. In an embodiment of the invention, an AC power cable 163 is coupled between a second AC adapter plug and the projection screen assembly 120, e.g., the control assembly 135 in the projection screen assembly 120.

FIG. 2C illustrates a block diagram of electrical components of the projection screen assembly. The projection screen assembly 120 receives the AC power at the control assembly 135. The control assembly 135 also includes a step-down voltage converter 250 (which may be a transformer). For example, the voltage converter 250 may receive an AC signal and covert the AC input voltage signal to an operating voltage for the motor control module 260, e.g., 3.3 Volts, 5 Volts, 12 Volts. The motor control module 270 may include a controller that sends signals to drive the motor 275 which drives the projection screen 131. The motor 275 itself may have an AC input which receives AC power. The step down converter 250 may also supply an operating voltage to the control module 290 in the control assembly 135. In an embodiment of the invention, the control module 290 and the motor control module 260 may be located on the same physical board, i.e., a control assembly 135.

The control module 290 may include an infrared receiver 295 for receiving control signals from a remote control device. The control assembly 135 also may include an AC output port 296 (or adapter plug) to transmit AC power to the projector assembly 110. A cable 163 may be plugged into the AC output port 296 and is connected to an AC input port of the projector 110.

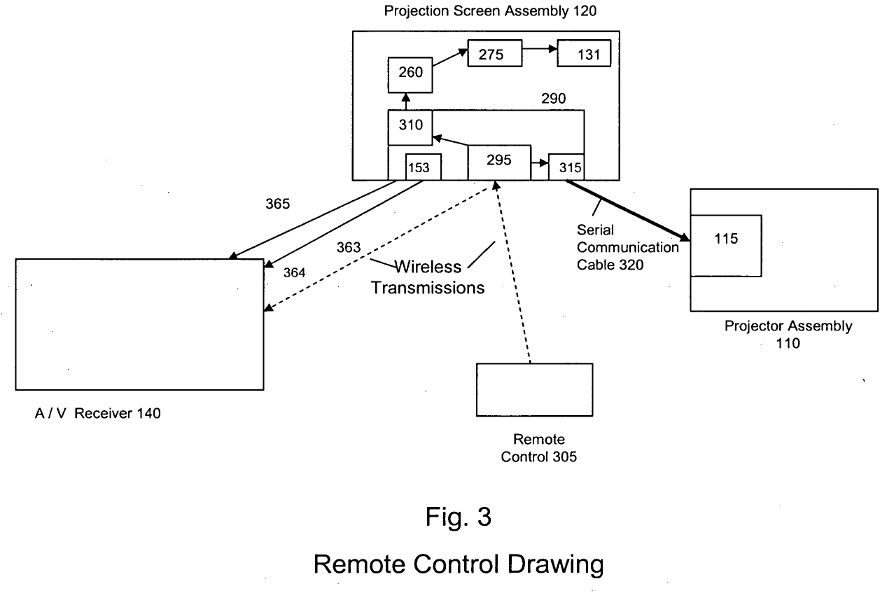

FIG. 3 illustrates remote control operation of the EZ home cinema system. A remote control device 305 may control the EZ home cinema system. The remote control device 305 transmits codes via infrared transmission. The codes may be standard remote control codes. In an embodiment of the invention, an infrared receiver 295 in the control module 290 of the projection screen assembly 120 may receive the transmitted code. Codes may control the screen 131 in the projection screen assembly 120 to raise (go up), deploy (go down) or stop. If the received code is directed for the projection screen assembly 120, the infrared transceiver 295 transmits the received code to a microcontroller 310 on the control board 290. The controller or microcontroller 310 transmits a signal to the motor control board 260 which in turn sends a signal to the motor 275. In an embodiment of the invention, the microcontroller 310 and the control board 260 are on the same physical printed circuit board and in an alternative embodiment, they are on a separate physical printed circuit board. The motor 275 engages a roller which deploys, raises or stops the projection screen 131.

If the received code is for a DVD player in the A/V receiver 140, the infrared or low frequency RF transceiver 295 in the control board 290 transmits the received code through a repeater to the A/V receiver 140. In an embodiment of the invention, the transmission is via an existing wire (as indicated by line 365) connected between the A/V receiver 140 and the control board 290. In an embodiment of the invention, the transmission is via an infrared wireless channel (as indicated by line 363) transmitted by the infrared or low frequency RF transceiver 295 to the A/V receiver 140.

In an embodiment of the invention, this transmission (as indicated by line 364) is a wireless transmission. In this embodiment of the invention, the transmission of remote control codes is via wireless video channel or signal (such as wireless HDMI channels). In an embodiment of the invention where the projection screen assembly 120 includes a wireless receiver 153, the control assembly may also include an infrared receiver 295 that receives the control code from the remote control. The wireless receiver 153 may be a transceiver in that it can also transmit wirelessly as well as received information wirelessly. The infrared or low frequency RF receiver 295 transmits the received remote control codes to the wireless transceiver 153. The wireless transceiver 153 transmits the received remote control codes to the audio and/or video source (e.g., a DVD player) via a wireless video and audio channel (e.g., a HDMI channel or a WHDI channel). In this way, no cable is needed to transfer remote control codes to the audio and video source and an existing wireless channel can be utilized.

If the received code is for the projector 115, e.g., adjusting contrast or brightness, or turning on the projector 115, then the codes are transmitted to the projector 115 in the projector assembly 110. The received code may be transmitted from the infrared or low frequency RF transceiver 295 utilizing a serial transmission protocol to the projector 115. Under certain operating conditions, the control board 290 may include a serial transmitter 315 which receives the code from the transceiver and transmits the code (or a signal representative of the code) serially via an RS-232 cable 320 to the projector 115.

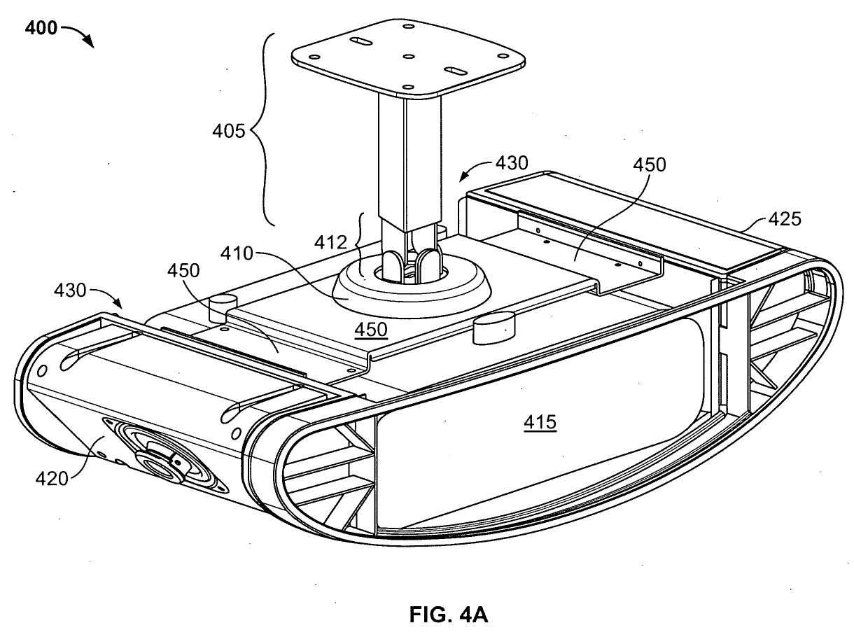

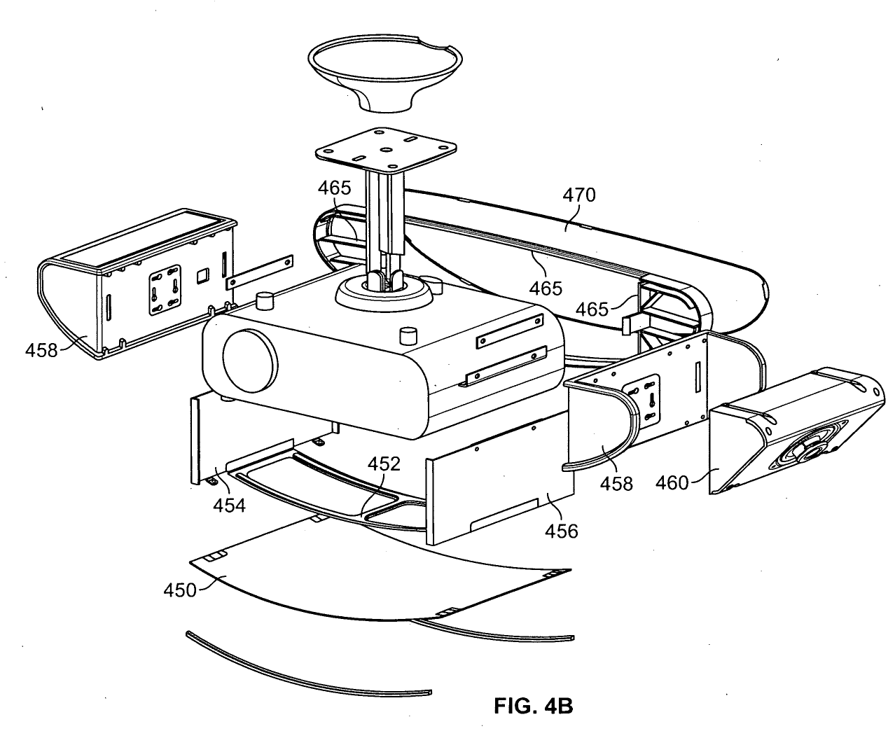

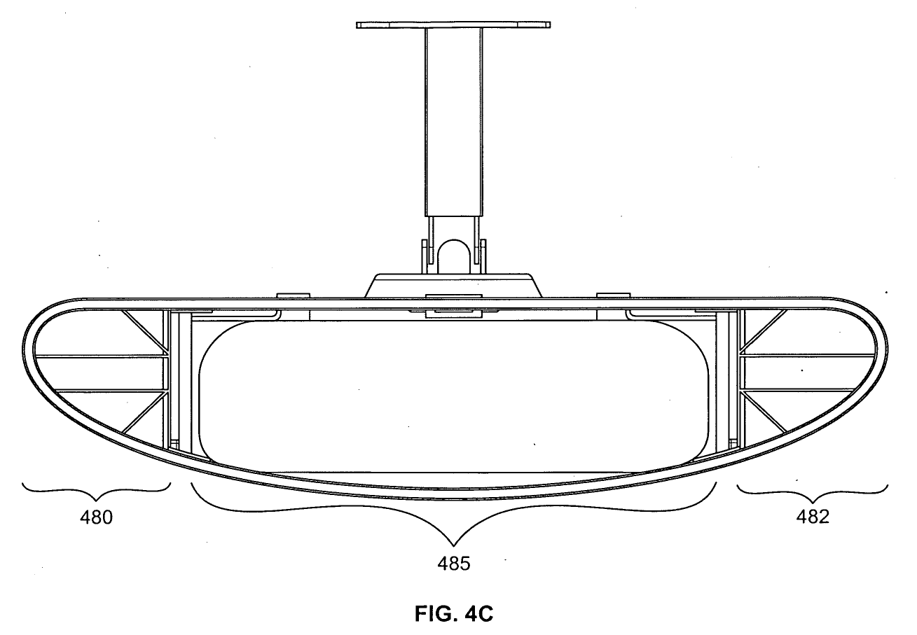

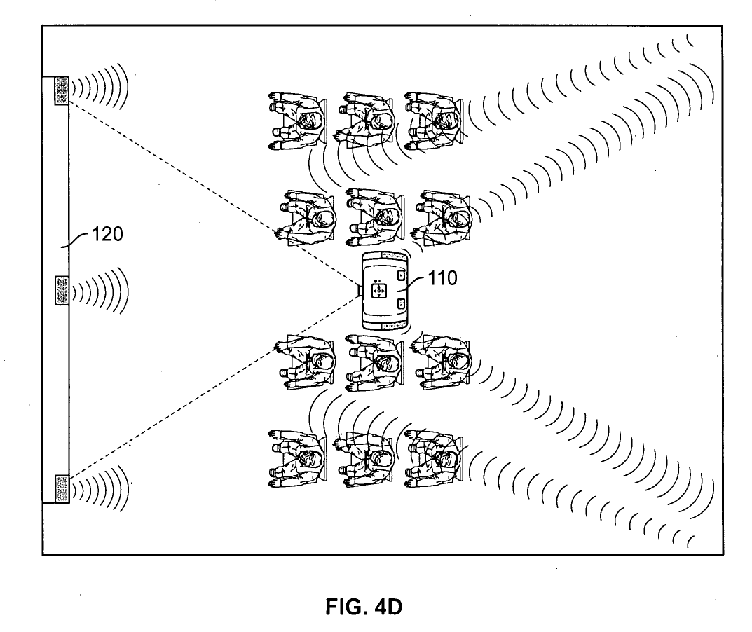

FIGS. 4A, 4B, and 4C illustrate a projector assembly according to an embodiment of the invention. FIG. 4A illustrates a top perspective view of a projector assembly according to an embodiment of the invention. The EZ Home Cinema system may include a projector assembly 400. The projector assembly 400 may include a mount 405, a plate 410, a swivel subassembly 412, a support assembly 430, a projector 415, and a plurality of speakers 420 and 425. The projector assembly 400 may be connected to the projection screen assembly 120 via a projector cabling system (not shown). The projector cabling system may include conductors, cables, or wires for power and audio signals. The projector cabling system may also include a conductor carrying a video signal. The projector cabling system may also include a RS232 cable for transmitting command signals from the projection screen assembly 120 to the projector 415. The conductor, wire, or cable carrying the video signal (and/or the RS232 signal) may be coupled to the projector 415 (e.g., at a video input connector and a RS232 input connector of the projector 415). The projector 415 may receive the video signal and project an image representative of the video signal, such as the movie that was originally read from the DVD in the A/V receiver 140.

The projector mount 405 may be connected to a surface of a viewing area, such as a ceiling of a room. The projector plate 410 may be connected to the projector mount 405 via a swiveling assembly 412. The swiveling assembly 412 may allow the projector 415 to be placed in a number of positions to change image quality or image directional focus. In an embodiment of the invention, the projector plate 410 may also be connected to an outside surface of the projector 415. In an embodiment of the invention, the projector plate 410 may be connected to a top surface of the projector 415, whereas in an alternative embodiment of the invention, the projector plate 410 may be connected to a bottom surface of the projector 415.

In an embodiment of the invention, the projector plate 410 may be coupled to a projector support plate 450. In this embodiment of the invention, the projector support plate 450 may be connected to a surface of the projector 415, e.g., the top surface of the projector 415 or bottom surface of the projector 415. The projector 415 is placed in the support assembly 430.

FIG. 4B illustrates an exploded front view of the support assembly. FIG. 4C illustrates an exploded back view of the support assembly. The support assembly 430 is connected to the projector support plate 450 by side edges of the projector support plate 450. The support assembly 430 includes two side areas 480 and 482 and a center area 485, as illustrated in FIG. 4C. The projector 415 may be placed in the center area 485 of the support assembly 430.

The center area 485 of the support assembly 430 includes a bottom cover 450, a bottom support frame 452, and a plurality of side support frames 454 and 456. The bottom cover 450 is attached to plurality of side support frames 454 to form the center area 485 where the projector 415 is placed. The bottom support frame 452 provides extra support for the center area 485 of the support assembly 430. The side areas 480 and 482 include speaker mounting assemblies 458 and speaker assemblies 460. The speaker mounting assemblies 458 are connected or attached to the side support assemblies 454 and 456. The speaker assemblies 460 are then placed in the speaker mounting assemblies 458. In an embodiment of invention, a mesh cover may cover the speaker assemblies 460 to prevent a user from touching the speaker assembly 460 or to view the speaker assembly 460. The mesh cover should not impact the quality of sound produced by a speaker in the speaker assembly 460.

A back support frame 465 may be connected to the side support assemblies 454 and 456, and the speaker mounting assemblies 458. The back support frame 465 may have openings to allow for venting of the projector 415 and also for cable placement behind the projector 415. A back cover 470 is attached to a back surface of the back support frame 465 of the support assembly 430. The back cover 470 provides protection so that users or viewers do not stick their hands inside the projector assembly 400. The back cover 470 runs across a back face of the side areas 480 and 482 and the center area 485. The front face of the center area 485 does not have a cover because the lens assembly of the projector 415 is facing in that direction and images would not be able to be projected.

The rear speakers 420 and 425 (see FIG. 1), which are integrated into the projector assembly 110, serves as the left and the right surround sound speakers in a 5.1 audio system. When installing surround sound audio systems, a problem often arises with the running of wires to connect to the speakers, e.g., rear speakers 420 and 425, in the back corners of the room. In an embodiment of the invention, the left rear speaker, e.g., speaker 420, and the right rear speaker, e.g., speaker 425, are installed on the ceiling in a more central location, as compared to the rear corners of the room. The surround sound produced from reflection of the sound off of the rear and rear side walls, from a central ceiling position, can produce an acceptable surround sound which has about the same quality as the surround sound produced by the more difficult installation of the surround sound speakers located in the corners of the room. An additional advantage of the centrally located speakers 420 and 425 is that the drivers therein can be angled downward. In an embodiment of the invention, the speakers are angled away from the projector assembly. The speakers may be angled downward in a range of between 25-75 degrees. The speakers may also be angled to face in a rearwardly direction. The speakers may be angled in a rearwardly and downward direction. Alternatively, the speakers may be angled upward. This is a benefit of having the projector assembly and the speakers 420 and 425 located in the center of the room. FIG. 4D illustrates how sound is reflected from the central location to the rear walls and then to viewers in the center of the room.

In an embodiment of the invention, the speakers are directly connected to the mounting assembly. This may result in the speakers not producing a vibration on the projector 110. In an embodiment of the invention, the speakers may be installed in the side support assemblies, which are connected to the same upper mount as the projector, but where vibration damping mechanisms may be employed to isolate them from the projector vibrationally. For example, the vibration damping mechanism may be a spring connected between the side support assembly and the speakers, a spring or like device connected between the speakers and the mounting assembly. In addition, material may be placed in the side support assembly or on the mounting bracket (where the speakers are connected or coupled to) to dampen the vibration of the speakers.

In an embodiment of the invention, the audio signal transmitted to the speakers may be notched or filtered to reduce the audio signal at frequencies that may cause resonance or vibration of the speaker assembly. In an embodiment of the invention, in the projector assembly, the received audio signals would be passed through an audio filter, which would notch the amplified audio signal to reduce the amplified audio signal at frequencies that cause the resonance or vibration. In an embodiment of the invention, vibration reduction materials are added to the frame of the projector assembly 110 in the area where the projector is sitting or resting. In an embodiment of the invention, the center support assembly includes the vibration reduction materials. These materials reduce the vibration of the projector assembly when the speakers are driving and producing sound.

In the embodiments of the invention illustrated in FIGS. 1C and 1D, the wireless audio receiver and audio amplifier have been built-in to power the wirelessly received audio signal to the speakers. Illustratively, a dongle may include a wireless to receive the wireless audio and video transmission. The dongle may be connected to an audio input jack and/or a video input jack. In an embodiment of the invention, the plurality of speakers may be connected to an audio output jack of the projector, which provides power and channels of the audio signal to the plurality of speakers.

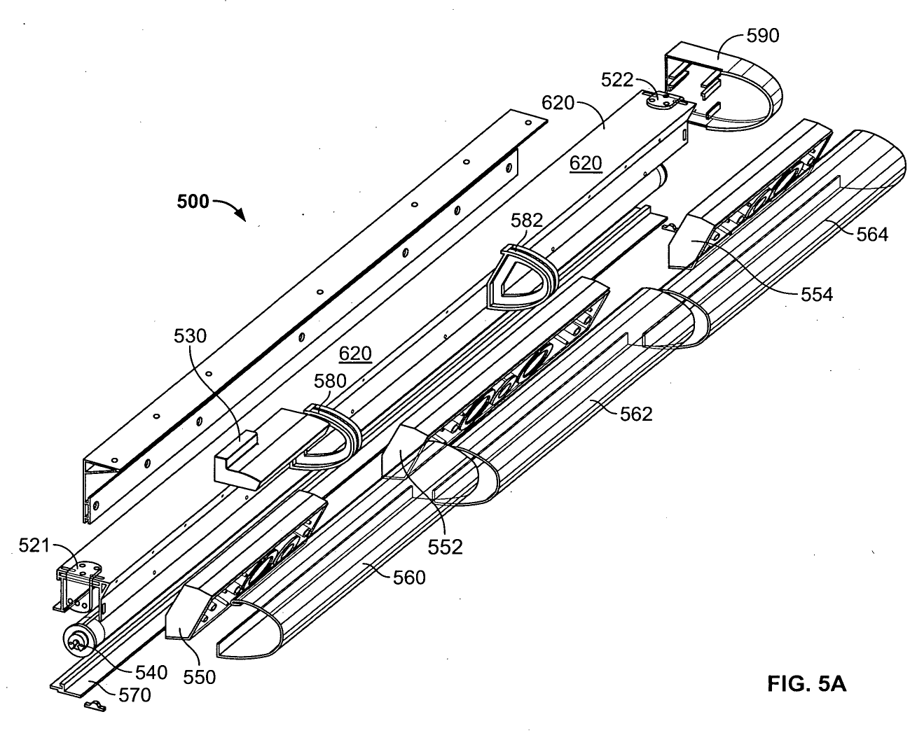

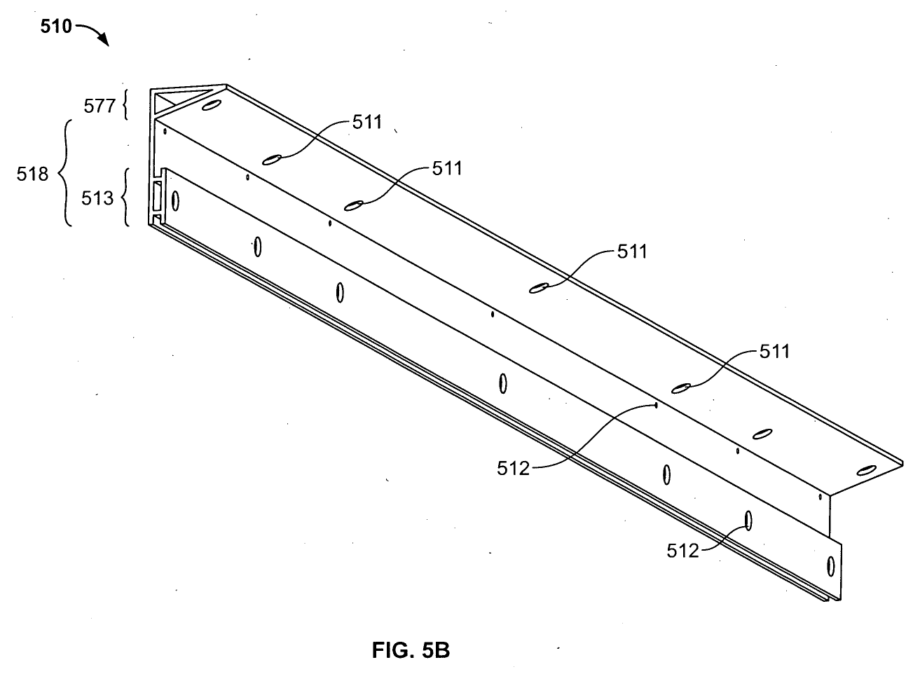

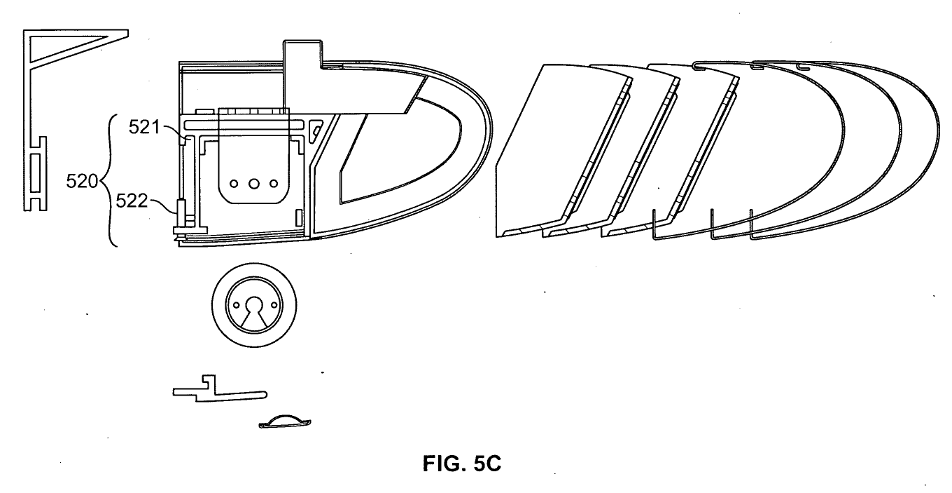

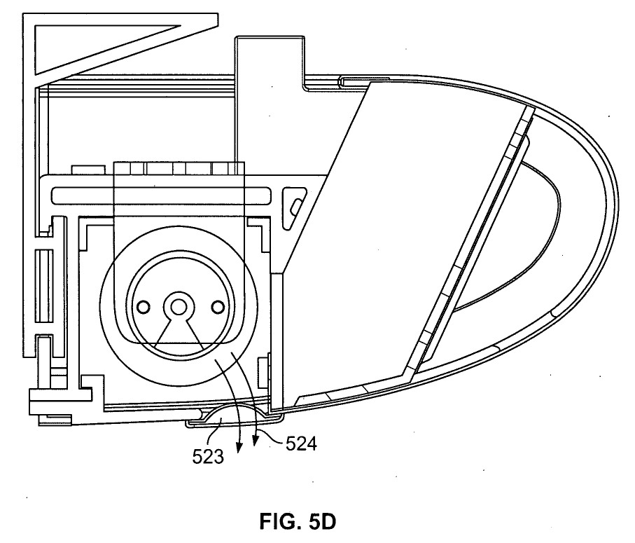

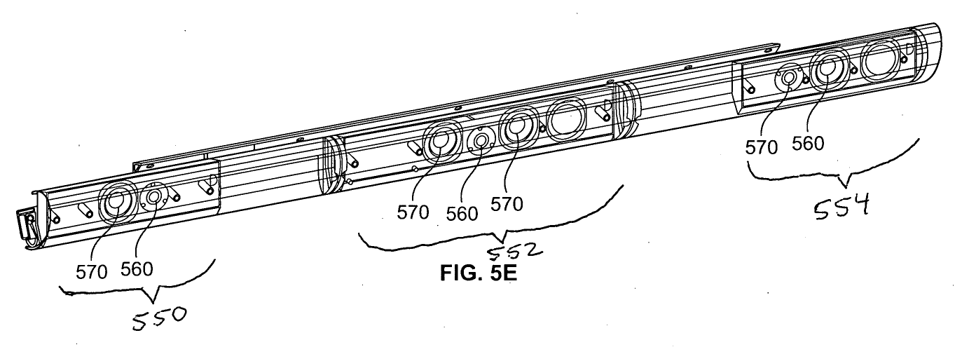

FIGS. 5A, 5B, 5C, 5D, and 5E illustrate a projection screen assembly according to an embodiment of the invention. FIG. 5A illustrates an exploded top perspective view of the projection screen assembly according to an embodiment of the present invention. The projection screen assembly 500 includes a main housing 620 (may be referred to as a main extrusion), a control box 530, a screen assembly 540, a motor (not shown), speaker assemblies 550, 552, and 554, cover assemblies 560, 562, and 564, and a main housing bottom cover 570, cover support brackets 580 and 582, and end brackets 590.

FIG. 5B illustrates a mounting assembly for the projection screen assembly according to an embodiment of the invention. A mounting assembly 510 fastens a projection screen assembly 500 to walls or surfaces. The mounting assembly 510 includes a plate 577 including horizontal fastening holes 511 to allow fasteners to connect the projection screen assembly 500 to a horizontal surface, such as a ceiling. The mounting assembly 510 may also include a plate 513 including vertical fastening holes 512 to allow fasteners to connect the projection screen assembly 500 to a vertical surface, such as a wall. The plate 577 and plate 513 form a one-piece mounting bracket 518. The main housing 620 of the projection screen assembly 500 may be snapped into place over a protruding mounting bar 513 of the mounting assembly 510. The main housing 620 includes a receiving area 521 and a latch 522 (as illustrated in FIG. 5C) to allow the main housing 620 to rest on the mounting bar 513. FIG. 5C illustrates a side view of a semi-exploded view of the projection screen assembly according to an embodiment of the invention.

The screen assembly 540 rests within the main housing 620. The screen assembly 540 may be a 100 inch diagonal screen using a 16:9 aspect ratio. Side brackets 521 and 522 are connected to the screen assembly 540. In an embodiment of the invention, the side brackets 521 and 522 are also connected to a top surface of the main housing 620. The main housing bottom cover 570 is installed on a bottom side of the main housing 620 and prevents the screen assembly 540 from falling out of the main housing 620. The main housing also includes a screen deployment gasket 523, such as the one illustrated in FIG. 5D. FIG. 5D is a view from a left side of the projection screen assembly. When viewing the main housing 620 from the left side, as is shown in FIG. 5D, the screen deployment gasket 523 is shown in a closed position, e.g., when the screen is not deployed and is stored in the main housing 620. If the screen is being deployed, (e.g. dropped down) or being raised up, the screen deployment gasket 523 may be moved, e.g., to one side or downward, to allow the screen to exit the main housing 620 in a direction as is illustrated by arrow 524.

The control assembly 530 may be attached to a top surface of the main housing 520. The control assembly 530 may be placed on a top surface so as to allow the infrared receiver, which is disposed on a control board in the control assembly 530, to receive signals from a remote control. In addition, the placement of the control assembly 530 keeps the control assembly 530 away from the screen assembly 540 and any movement associated with the screen assembly 540.

Referring to FIG. 5A, the speaker assemblies 550, 552, and 554 are connected to a front face of the main housing 620. In an embodiment of the invention, the left speaker subassembly 550 includes the front left speaker, the center speaker subassembly 552 includes the front center speaker, and the right speaker subassembly 554 includes the front right speaker. In an embodiment of the invention, the speaker subassemblies 550, 552, and 554 are placed so that the speakers are facing slightly downward, as is illustrated in FIG. 5A. This projects the sounds emitted from the speakers in a downward direction towards the user. As illustrated in FIG. 5E, the speaker assemblies 550, 552, and 554 each include a tweeter 560 and a woofer 570. In an embodiment of the invention, the speaker assemblies 550, 552, and 554 may also include a plurality of tweeters 560 and/or woofers 570. In an embodiment of the invention, the center channel is most important channel and has more information (voice) and typically has more audio power. Thus, the speaker assembly in the center of the projection screen assembly may include a plurality of woofers because the center channel is the most important channel.

In an embodiment of the invention, the cover assemblies 560, 562, and 564 may be installed to cover the speaker assemblies 550, 552, and 554. In an embodiment of the invention, the cover assemblies 560, 562, and 564 may have a similar or the same length as the speaker assemblies 550, 552, and 554. Alternatively, one or more of the cover assemblies 560, 562, and 564 may have a larger length than that of the speaker assemblies 550, 552, and 554. For example, as illustrated in FIG. 5A, the left cover assembly 560 may have a longer length than the left speaker assembly 550. The left cover assembly 560 may be connected to a left end cap (not shown) and also a cover support bracket 580. The center cover assembly 562 may be connected to the cover support bracket 580 and the cover support bracket 582. The right cover assembly 564 may be connected to the cover support bracket 582 and the right end bracket 590. The cover assemblies 560, 562, and 564 may be made of cloth, plastic, metal or other commonly used audio speaker grill materials.

In embodiments of the invention, the projection screen assembly may include an equalizer. The equalizer may be utilized to modify characteristics of channels of the amplified audio signals to address room characteristics and location of the projection screen assembly compared to the back wall and the ceiling.

In embodiments of the invention, the equalizer may be located in a separate physical device from the projection screen assembly. Illustratively, the equalizer may be located in the audio/video source or in a separate equalizer component.

In an embodiment of the invention, a user may be able to adjust equalizer settings. Under certain operating condition, the selection of equalizer settings may be accomplished via the remote control. The equalizer settings may also be established by manually selecting predetermined settings (via a knob or button). In addition, a test may be conducted in the room where the projector assembly and projection screen assembly are located to determine sound characteristics of the room, (or alternatively a viewing area). These unique settings may be stored in an equalizer and transmitted (or sent) to the audio/video source. The audio/video source may utilized the unique equalizer settings for the room (or viewing area) and modify the amplified audio signals accordingly.

The equalizer settings may be based on an installation location of the projection screen assembly in the room or viewing area. For example, if the speakers in the projection screen assembly are located about twelve inches from the ceiling of the room, the equalizer may adjust frequencies and/or amplitude of the audio signals in order to minimize the quality of the sound caused by the reflecting of the reproduced sound off of the ceiling, which may be significantly different versus having projection screen assembly installed on a wall flush to the ceiling. In addition, the equalizer may also adjust frequencies based on the position of the projection screen assembly to a wall behind the projection screen assembly. The equalizer may also adjust frequencies based on the room (or viewing area acoustics). As noted before, the equalizer may also be a DSP (digital signal processor) that can dynamically adjust EQ settings based on the room acoustics and placement of the screen on the wall or ceiling.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A projector assembly, comprising:
a projector for projecting images;
a plurality of speakers for reproducing sound;
a mounting bracket connected to a surtace; and
a support assembly connected to the mounting bracket, wherein the projector and the plurality of speakers are supported by the support assembly.

2. The projector assembly of claim 1, wherein the projector rests within a center area of the support assembly.

3. The projector assembly of claim 1, wherein the plurality of speakers is two speakers and one of the plurality of speakers is located in a first side area of the support assembly and another one of the plurality of speakers is located in a second side area of the support assembly.

4. (canceled)

5. The projector assembly of claim 1, wherein a first speaker of the plurality of speakers is a right rear surround sound speaker and a second speaker of the plurality of the speakers is the left rear surround sound speaker.

6. The projector assembly of claim 1, wherein the support assembly includes a back cover and a bottom cover to protect a rear and bottom of the projector and the plurality of speakers from objects or hands touching inputs of the projector or speaker and provides better aesthetic appearance

7. The projector assembly of claim 1, wherein the plurality of speakers are directed away from the support assembly.

8. The projector assembly of claim 1, further including a swiveling assembly, connected between the mounting bracket and the support assembly, to allow adjustment of the projector with respect to the projection screen.

9. The projector assembly of claim , wherein the plurality of speakers in the support assembly are connected to speaker mounting assemblies in the side areas of the support assembly, and the speaker mounting assemblies include adjustment mechanisms to allow for directional adjustment of sound output from the speakers.

10. The projector assembly of claim 1, where at Least one of the plurality of speakers are connected directly to the mounting assembly to minimize vibration of the projector during operation of the plurality of speakers.

11. The projector assembly of claim 1, wherein the audio signal transmitted to the speakers has been filtered to reduce amplitude of the audio signal at frequencies that cause resonance or vibration of the projector assembly.

12. (canceled)

13. A projection system, comprising:
a projector for projecting an image;
a mounting assembly;
a projection screen assembly, the projection screen assembly including
a first plurality of speakers for reproducing sound transmitted thereto; and
a projection screen to receive the projected image, wherein the projection screen assembly is mounted to the mounting assembly and the mounting assembly can be mounted to a horizontal surface and a vertical surface; and
a power cable to provide AC power between the projection screen assembly and the projector in the projector assembly.

14. The projection system of claim 13, wherein the projection screen is a motorized screen.

15. The projection system of claim 13, wherein a first speaker of the first plurality of speakers is a front right sound speaker, a second speaker of the first plurality of speakers is a front center sound speaker, and a third speaker of the first plurality of speakers is a front left sound speaker.

16. The projection system of claim 13, wherein the projection screen assembly further includes a housing, the projection screen being installed inside the housing and the first plurality of speakers being connected to a front face of the housing, and a control assembly.

17. The projection system of claim 16, wherein the projection screen is a motorized screen and the control assembly includes a transceiver which receives codes from a remote control, the codes being instructions for operating the motorized screen, and the codes being interpreted by a microcontroller which transmits a signal to a motor control board to drive a motor connected to the motorized screen.

18. (canceled)

19. The projection system of claim 14, wherein the control assembly include a transceiver which receives codes from a remote control and if the codes are instructions for a projector, transmitting the codes to the projector utilizing a serial transmission protocol.

20. The projection system of claim 13, further including a second plurality of speakers, a second mounting bracket, and a support assembly, the second mounting bracket being connected to a vertical surface and the support assembly being connected to the second mounting bracket, wherein the support assembly surrounds the projector and the second plurality of speakers.

21. The projection system of claim 20, wherein a first speaker of the second plurality of speakers is a rear right surround sound speaker and a second speaker of the second plurality of speakers is a rear left surround sound speaker.

22. The projection system of claim 21, wherein a projector assembly including the projector, the support assembly, and the second plurality of speakers, further including cabling between a cable junction in the projection screen assembly and audio cable in the projector assembly.

23. (canceled)

24. The projection system of claim 22, the cabling carrying video signals from the cable junction device in the projection screen assembly to a video input the projector assembly.

25. The projection system of claim 22, wherein the cabling is low profile cabling which is installed on a ceiling of a viewing area.

26. A home cinema system, comprising:
an audio/video source that transmits an audio signal and a video signal using a wireless communication protocol;
a projection screen assembly, the projection screen assembly including:
a projection screen to reflect projected images;
a wireless receiver to receive the wirelessly transmitted audio signal and video signal;
a transmitter to transmit channels of the received audio signal and video signal; and
a first plurality of speakers to reproduce sound corresponding to channels of the received audio signal;
a first mounting assembly to connect the projection screen assembly to a ceiling of the viewing area and a horizontal surface of the viewing area;
a cable to receive the transmitted channels of the audio signal and the video signal;
a projector to project images corresponding to the received video signal, the projector receiving from the cable the transmitted channels of the audio signal and the video signal.

27. The home cinema system of claim 26, wherein the projection screen assembly further includes an amplifier to amplify the audio signal received by the wireless receiver and transmit the amplified audio signal to the transmitter

28. The home cinema system of claim 26, wherein the wireless receiver and the transmitter is located on a control assembly.

29. The home cinema system of claim 26, further including an infrared receiver or RF receiver to receive remote control codes.

30. A home cinema system, comprising:
an audio/video source that transmits an audio signal and a video signal using a wireless communication protocol;
a projector assembly, the projector assembly including:
a wireless receiver to receive the wirelessly transmitted audio signal and video signal;
a projector to project images corresponding to the wirelessly received video signal; and
a transmitter to receive the wirelessly transmitted audio signal and video signal from the wireless receiver and to transmit channels of the received audio signal; and
a cable to receive the transmitted channels of the audio signal and the video signal;
a projection screen assembly, the projection screen assembly including
a projection screen to reflect the projected images from the projector; and
a second plurality of speakers to reproduce sound based on the channels of the audio signal received from the cable, wherein a cable junction is coupled to the cable and also coupled to the second plurality of speakers; and
a mounting assembly to connect the projection screen assembly to the ceiling or wall.

31. The home cinema system of claim 30, wherein the wireless receiver and transmitter are located in a dongle attached to at least one input port of the projector.

32. The home cinema system of claim 30, wherein a first power cable provides AC power to the projection screen assembly and is connected to a cable junction and a second power cable provides AC power from the projection screen assembly to the projector by connecting to the cable junction and an input power interface of the projector.

33. The home cinema system of claim 30, wherein the first plurality of speakers are directed away from the projector assembly.

34. The home cinema system of claim 33, wherein the first plurality of speakers are directed downwardly and rearwardly from the projector assembly.

35. The home cinema system of claim 33, further including a mounting assembly to mount the projector assembly to the ceiling of the viewing area.

36. A home cinema system, comprising:
an audio/video source that transmits an audio signal and a video signal using a wireless communication protocol;
a projection screen assembly, the projection screen assembly including:
a projection screen to receive projected images;
a first wireless receiver to receive the wirelessly transmitted audio signal and video signal; and
a first plurality of speakers to reproduce sound corresponding to channels of the received audio signal;
a first mounting assembly to connect the projection screen assembly to a ceiling or wall; and
a projector assembly, the projector assembly including
a second wireless receiver to receive the wirelessly transmitted audio signal and video signal;
a projector to project images corresponding to the video signal received by the second wireless receiver; and
a second plurality of speakers to project corresponding to channels of the audio signal received at the wireless receiver.

37. The home cinema system of claim 36, further including a second mounting assembly to connect the projector assembly to a ceiling of the viewing area.

38. The home cinema system of claim 37, further including a second wireless receiver and transmitter to receive control codes from a remote control, wherein the wireless receiver and transmitter can be located in the projection screen assembly or the projector screen assembly.

39. The home cinema system of claim 38, wherein the received remote control signals are sent by the transmitter over a wireless connection to an audio/video source.

40. A projection screen assembly, comprising:
a projection screen to allow images to be projected thereon; and
a plurality of speakers to reproduce channels of audio signals transmitted to the plurality of speakers, wherein the channels of audio signals have been equalized based on an installation location of the projection screen assembly within a room.

41-42. (canceled)

43. The projection screen assembly of claim 40, further including a motor to drive the projection screen.

44. The projection screen assembly of claim 40, wherein equalization is selected manually based on a number of predetermined settings.

45. The projection screen assembly of claim 40, wherein equalization is completed based on an automatic calculation by an equalization measuring device and an equalization setting device.

46. (canceled)
